(19) United States
(12) Patent Application Publication
(10) Pub. No.: US 2021/0049447 A1
(43) Pub. Date: Feb. 18, 2021

(54) NEURAL NETWORK PROCESSING METHOD AND EVALUATION METHOD, AND DATA ANALYSIS METHOD AND DEVICE

(71) Applicant: BOE TECHNOLOGY GROUP CO., LTD., Beijing (CN)

(72) Inventors: Pablo NAVARRETE MICHELINI, Beijing (CN); Hanwen LIU, Beijing (CN); Yunhua LU, Beijing (CN)

(21) Appl. No.: 17/042,265

(22) PCT Filed: Dec. 23, 2019
(86) PCT No.: PCT/CN2019/127431

§ 371 Date: Sep. 28, 2020

(30) Foreign Application Priority Data
Jan. 25, 2019 (CN) 201910075152.0

(51) Int. Cl. G06N 3/04; G06N 3/063; G06N 3/08; G06K 9/62

(52) U.S. Cl. CPC G06N 3/0481; G06K 9/6256; G06N 3/08; G06N 3/063

(57) ABSTRACT

A processing method and a processing device of a neural network, an evaluation method of the neural network, a data analysis method and device, and a storage medium are provided. The processing method of the neural network includes: processing an input matrix input to an N-th nonlinear layer in at least one nonlinear layer by using the N-th nonlinear layer to obtain an output matrix output by the N-th nonlinear layer; according to the input matrix and the output matrix, performing linearization processing on the N-th nonlinear layer to determine an expression of a linear function corresponding to the N-th nonlinear layer.

### CROSS-REFERENCE TO RELATED APPLICATION

The present application claims priority of Chinese Patent Application No. 201910075152.0, filed on Jan. 25, 2019, and the entire content disclosed by the Chinese patent application is incorporated herein by reference as part of the present application.

### TECHNICAL FIELD

Embodiments of the present disclosure relate to a processing method and a processing device of a neural network, an evaluation method of a neural network, a data analysis method and a data analysis device, and a computer-readable storage medium.

### BACKGROUND

At present, deep learning technology based on artificial neural network has made great progress in fields, such as object classification, text processing, recommendation engine, image search, face recognition, age and speech recognition, human-machine conversation, affective computing, and the like. Artificial neural network includes Convolution Neural Network (CNN), the convolution neural network is a kind of feedforward neural network that comprises convolution calculation and has a deep structure, and is one of the representative algorithms of deep learning. The convolution neural network is a nonlinear system, which includes a plurality of layers and nonlinear units connecting the plurality of layers. These nonlinear units can allow the convolution neural network to adapt to various inputs.

### SUMMARY

At least some embodiments of the present disclosure provide a processing method of a neural network, the neural network comprises at least one nonlinear layer, the processing method comprises: processing an input matrix input to an N-th nonlinear layer in the at least one nonlinear layer by using the N-th nonlinear layer to obtain an output matrix output by the N-th nonlinear layer; and according to the input matrix and the output matrix, performing linearization processing on the N-th nonlinear layer to determine an expression of an N-th linear function corresponding to the N-th nonlinear layer, the expression of the N-th linear function is expressed as:

f_{LN}=A_{N}*x+B_{N},

where f_{LN} represents the N-th linear function, A_{N} represents a first parameter of the N-th linear function, B_{N} represents a second parameter of the N-th linear function, x represents an input of the N-th nonlinear layer, A_{N} and B_{N} are determined according to the input matrix and the output matrix, N is a positive integer.

For example, in the processing method provided by some embodiments of the present disclosure, an expression of the first parameter of the N-th linear function is:

A_{N}=(Df_{NN}) (x1),

where Df_{NN} represents a first derivative of a nonlinear function corresponding to the N-th nonlinear layer, and x1 represents the input matrix; and an expression of the second parameter of the N-th linear function is:

B_{N}=f_{NN} (x1)−A*(x1),

where f_{NN} represents the nonlinear function corresponding to the N-th nonlinear layer, and f_{NN} (x1) represents the output matrix.

For example, the processing method provided by some embodiments of the present disclosure further comprises: performing the linearization processing on all nonlinear layers in the neural network to determine expressions of linear functions respectively corresponding to the all nonlinear layers.

For example, in the processing method provided by some embodiments of the present disclosure, the at least one nonlinear layer comprises an activation layer, an instance normalization layer, a maximum pooling layer, or a softmax layer, and an activation function of the activation layer is a ReLU function, a tanh function, or a sigmod function.

Some embodiments of the present disclosure also provide a data analysis method based on a neural network, and the data analysis method comprises: acquiring input data; processing the input data by using the neural network to obtain first output data; according to the input data and the first output data, executing the processing method according to any one of the above embodiments to perform the linearization processing on all nonlinear layers in the neural network to determine a linearized neural network corresponding to the neural network; and analyzing a corresponding relationship between the input data and the first output data based on the linearized neural network.

For example, in the data analysis method provided by some embodiments of the present disclosure, analyzing the corresponding relationship between the input data and the output data based on the linearized neural network comprises: determining a detection data group according to the input data, where the detection data group is a binary matrix group; processing the detection data group by using the linearized neural network to obtain a second output data group; and analyzing a positive influence or a negative influence between the input data and the first output data based on the detection data group and the second output data group.

For example, in the data analysis method provided by some embodiments of the present disclosure, the detection data group comprises at least one detection data, and the second output data group comprises at least one second output data, the at least one detection data is in one-to-one correspondence to the at least one second output data, analyzing the positive influence between the input data and the first output data based on the detection data group and the second output data group, comprises: processing the at least one detection data by using the linearized neural network, respectively, to obtain the at least one second output data; and determining the positive influence of respective input elements of the input data on respective output elements of the first output data by analyzing a corresponding relationship between the at least one detection data and the at least one second output data at an element level. Each detection data in the detection data group comprises a target detection element, a value of the target detection element is one, and values of other detection elements in each detection data except the target detection element are all zero.

For example, in the data analysis method provided by some embodiments of the present disclosure, in a case where the detection data group comprises a plurality of detection data, positions of target detection elements in at least part of the plurality of detection data are different.

For example, in the data analysis method provided by some embodiments of the present disclosure, sizes of the plurality of detection data are identical, and the sizes of the plurality of detection data and a size of the input data are also identical.

For example, in the data analysis method provided by some embodiments of the present disclosure, the detection data group comprises a plurality of detection data, and the second output data group comprises a plurality of second output data, the plurality of detection data are in one-to-one correspondence to the plurality of second output data, analyzing the negative influence between the input data and the first output data based on the detection data group and the second output data group, comprises: processing the plurality of detection data by using the linearized neural network, respectively, to obtain the plurality of second output data; and determining the negative influence of respective output elements of the output data on respective input elements of the input data by analyzing a corresponding relationship between the plurality of detection data and the plurality of second output data at an element level. Each detection data in the detection data group comprises a target detection element, a value of the target detection element is one, values of other detection elements in each detection data except the target detection element are all zero, an amount of the plurality of detection data is identical to an amount of all detection elements in each detection data, and positions of target detection elements of any two detection data in the plurality of detection data are different.

At least some embodiments of the present disclosure also provide an evaluation method of a neural network, and the evaluation method comprises: executing the processing method according to any one of the above embodiments to determine at least one linear interpretation unit corresponding to the at least one nonlinear layer; and evaluating the neural network based on the at least one linear interpretation unit.

For example, in the evaluation method provided by some embodiments of the present disclosure, evaluating the neural network based on the at least one linear interpretation unit, comprises: evaluating the at least one linear interpretation unit to determine an evaluation result of the at least one nonlinear layer; and training the neural network based on the evaluation result.

For example, in the evaluation method provided by some embodiments of the present disclosure, training the neural network based on the evaluation result, comprises: determining a training weight of the at least one nonlinear layer based on the evaluation result; acquiring training input data and training target data; processing the training input data by using the neural network to obtain training output data; calculating a loss value of a loss function of the neural network according to the training output data and the training target data; and modifying parameters of the neural network based on the training weight of the at least one nonlinear layer and the loss value, obtaining a trained neural network in a case where the loss function of the neural network satisfies a predetermined condition, and continuously inputting the training input data and the training target data to repeatedly execute the above training process in a case where the loss function of the neural network does not satisfy the predetermined condition.

At least some embodiments of the present disclosure also provide a processing device of a neural network, comprising: a memory, configured to store computer-readable instructions; and a processor, configured to execute the computer-readable instructions. The processing method according to any one of the above embodiments is executed in a case where the computer-readable instructions are executed by the processor.

At least some embodiments of the present disclosure also provide a computer-readable storage medium, for storing computer-readable instructions, and the processing method according to any one of the above embodiments is executed in a case where the computer-readable instructions are executed by a computer.

### BRIEF DESCRIPTION OF THE DRAWINGS

In order to clearly illustrate the technical solutions of the embodiments of the present disclosure, the drawings of the embodiments will be briefly described in the following; and it is obvious that the described drawings are only related to some embodiments of the present disclosure and thus are not limitative to the present disclosure.

FIG. 1 is a schematic diagram of a convolution neural network;

FIG. 2 is a schematic diagram of a few filters that are equivalent due to an activation result of an activation function in the convolution neural network;

FIG. 3 is a flowchart of a processing method of a neural network provided by some embodiments of the present disclosure;

FIG. 4 is a schematic diagram of a nonlinear layer and a linear function corresponding to the nonlinear layer provided by some embodiments of the present disclosure;

FIG. 5A is a schematic diagram of a partial structure of a neural network provided by some embodiments of the present disclosure;

FIG. 5B is a schematic diagram of a partial structure of a modified neural network provided by some embodiments of the present disclosure;

FIG. 6A is a structural schematic diagram of a neural network provided by some embodiments of the present disclosure;

FIG. 6B is a structural schematic diagram of a linearized neural network provided by some embodiments of the present disclosure;

FIG. 7 is a flowchart of a data analysis method based on a neural network provided by some embodiments of the present disclosure;

FIG. 8 is a flowchart of an evaluation method of a neural network provided by some embodiments of the present disclosure;

FIG. 9 is a flowchart of a training method of a neural network provided by some embodiments of the present disclosure;

FIG. 10 is a schematic diagram of a processing device of a neural network provided by some embodiments of the present disclosure; and

FIG. 11 is a schematic diagram of a data analysis device provided by some embodiments of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

In order to keep the following description of the embodiments of the present disclosure clear and concise, the present disclosure omits detailed descriptions of some known functions and known components.

Convolution neural network is a neural network structure that uses, for example, images as input and output, and replaces scalar weights by filters (convolution kernels). Convolution neural network includes many nonlinear layers, for example, an activation layer, an instance normalization layer, a maximum pooling layer, or a softmax layer, etc. are all nonlinear layers.

The convolution neural network is one of the representative algorithms of a deep learning system. At present, the main disadvantage of the deep learning system is that it is difficult to explain the working process of the neural network. In the deep learning system, a network architecture is selected first, and then the network architecture is trained to obtain a group of parameters (filter coefficients and biases). If the trained network is good, the output of the trained network will match the desired target with high precision for a given input. However, there are still many problems that are difficult to explain, such as: Is the trained network the best choice to solve the problem? Is the amount of parameters of the trained network sufficient? How do these parameters work in the trained network to get the output? And compared with a network with a few layers (shallow network), how can a network with many layers (deep network) help improve the accuracy of output.

The filters in the deep neural network architecture are usually small (3*3 convolution kernel or 5*5 convolution kernel, etc.), and visualizing a large amount of filters one by one cannot provide a deep understanding of the deep neural network architecture. In addition, bias is a scalar that cannot provide clues to the complex mechanisms working in the deep neural network architecture. Understanding the parameters of the deep learning system is still a difficult problem to a great extent.

At least some embodiments of the present disclosure provide a processing method and a processing device of a neural network, an evaluation method of a neural network, a data analysis method and a data analysis device, and a computer-readable storage medium. The processing method of the neural network can linearize the neural network to enable the neural network to become a linear system, so that the neural network can be analyzed by using the classical method of the linear system (for example, impulse response), and the understanding of how the neural network solves problems can be improved. Based on these understandings, the configuration of the neural network can also be optimized.

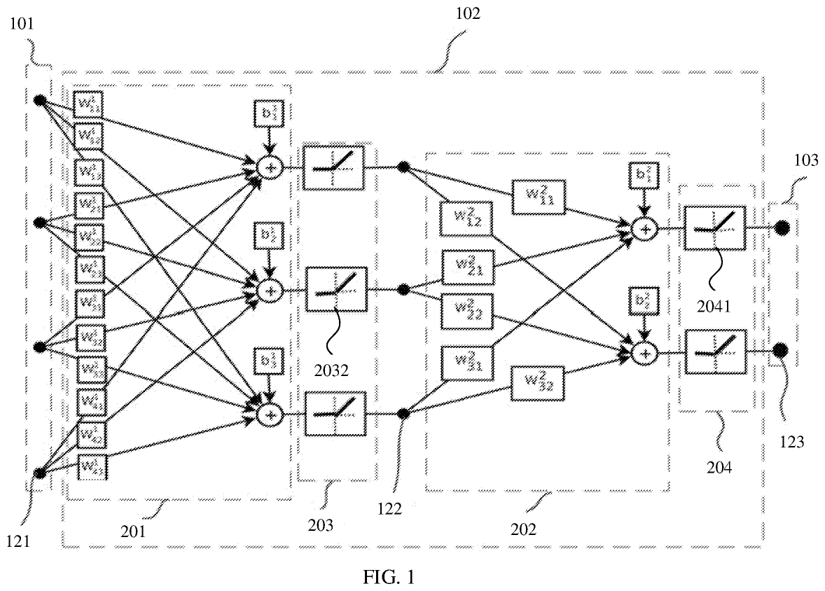

FIG. 1 is a schematic diagram of a convolution neural network. For example, the convolution neural network can be used to process images, speech, texts, etc. FIG. 1 only shows a convolution neural network with a three-layer structure, however, the embodiments of the present disclosure are not limited to this case. As shown in FIG. 1, the convolution neural network includes an input layer 101, a hidden layer 102, and an output layer 103. The input layer 101 has four inputs 121, the hidden layer 102 has three outputs 122, and the output layer 103 has two outputs 123. Finally, the convolution neural network finally outputs two images.

For example, the four inputs 121 of the input layer 101 may be four images or four features of one image. The three outputs 122 of the hidden layer 102 can be feature maps of images input through the input layer 101. The three outputs of the hidden layer 102 may be feature maps of images or features (for example, four inputs 121) input via the input layer 101.

For example, as shown in FIG. 1, each convolution layer has a weight wᵢⱼ^{k} and a bias bᵢ^{k}. The weight wᵢⱼ^{k} represents a convolution kernel, and the bias bᵢ^{k} is a scalar superimposed on the output of the convolution layer, where k represents a label of the input layer 101, and i is a label of the unit of the input layer 101 and j is a label of the unit of the hidden layer 102, respectively. For example, the hidden layer 102 may include a first convolution layer 201 and a second convolution layer 202. The first convolution layer 201 includes a first group of convolution kernels (wᵢⱼ¹ in FIG. 1) and a first group of biases (bᵢ¹ in FIG. 1). The second convolution layer 202 includes a second group of convolution kernels (wᵢⱼ² FIG. 1) and a second group of biases (b in FIG. 1). Generally, each convolution layer includes tens or hundreds of convolution kernels. If the convolution neural network is a deep convolution neural network, the convolution neural network can include at least five convolution layers.

For example, as shown in FIG. 1, the hidden layer 102 further includes a first activation layer 203 and a second activation layer 204. The first activation layer 203 is located behind the first convolution layer 201, and the second activation layer 204 is located behind the second convolution layer 202. The activation layer (e.g., the first activation layer 203 and the second activation layer 204) includes an activation function, and the activation function is used to introduce nonlinear factors into the convolution neural network, so that the convolution neural network can better solve more complex problems. The activation function may include a rectifying linear unit (ReLU) function, an S-type function (Sigmoid function) or a hyperbolic tangent function (tanh function), etc. For example, the activation layer can be used as a layer of the convolution neural network alone, or the activation layer can be included in the convolution layer (for example, the first convolution layer 201 can include the first activation layer 203, and the second convolution layer 202 can include the second activation layer 204).

For example, in the first convolution layer 201, first, several convolution kernels wᵢⱼ¹ in the first group of convolution kernels and several biases bᵢ¹ in the first group of biases are applied to each input 121 to obtain the output of the first convolution layer 201; then, the output of the first convolution layer 201 can be processed by the first activation layer 203 to obtain the output of the first activation layer 203. In the second convolution layer 202, first, several convolution kernels wᵢⱼ² in the second group of convolution kernels and several biases bᵢ² in the second group of biases are applied to the output of the first activation layer 203, which is input to the second convolution layer 202, to obtain the output of the second convolution layer 202; then, the output of the second convolution layer 202 can be processed by the second activation layer 204 to obtain the output of the second activation layer 204. For example, the output of the first convolution layer 201 may be the result of adding a result of applying the convolution kernel wᵢⱼ¹ to the input of the first convolution layer 201 to the bias, and the output of the second convolution layer 202 may be the result of adding a result of applying the convolution kernel wᵢⱼ² to the output of the first activation layer 203 to the bias. For example, as shown in FIG. 1, the output of the first activation layer 203 is the output 122 of the hidden layer 102, and the output of the second activation layer 204 is transmitted to the output layer 103 as the output 123 of the output layer 103.

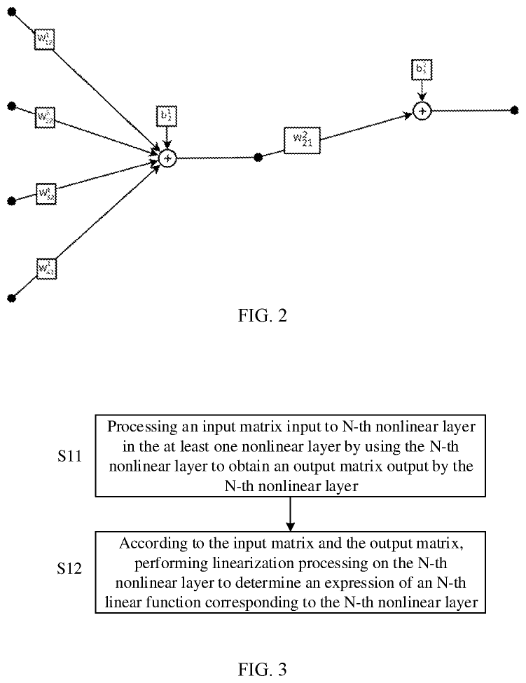

FIG. 2 is a schematic diagram of a few filters that are equivalent due to the activation result of the activation function in the convolution neural network. For example, the activation function can prevent the architecture of the whole convolution neural network from being reduced to a small group of filters acting on each input. Convolution neural network can be interpreted as an adaptive filter. If the activation layer includes the ReLU function, if the input of the activation layer includes a first part of input and a second part of input, if the first part of input is positive, the activation layer transmits the first part of input to the next layer unchanged; and if the second part of input is negative, the second part of input has no influence on the output of the activation layer. Assuming that, as shown in FIG. 1, the specific input of the second ReLU 2032 in the first activation layer 203 and the specific input of the first ReLU 2041 in the second activation layer 204 are activated, and the specific input is negative for the remaining ReLUs in the convolution neural network, that is, the remaining ReLUs do not affect the output. Therefore, as shown in FIG. 2, ReLUs except the second ReLU 2032 in the first activation layer 203 and the first ReLU 2041 in the second activation layer 204 are omitted, and a linear convolution neural network is obtained, the linear convolution neural network only includes four different filters and some biases, which act on each input. For different inputs, the activation states of respective ReLUs will be different, thus changing the output result of the convolution neural network. For any input, the net effect of convolution neural network is always equivalent to a small amount of filters and biases (for example, a group of filters and biases as shown in FIG. 2), but the group of filters changes with the input, thereby resulting in adaptive filter effect.

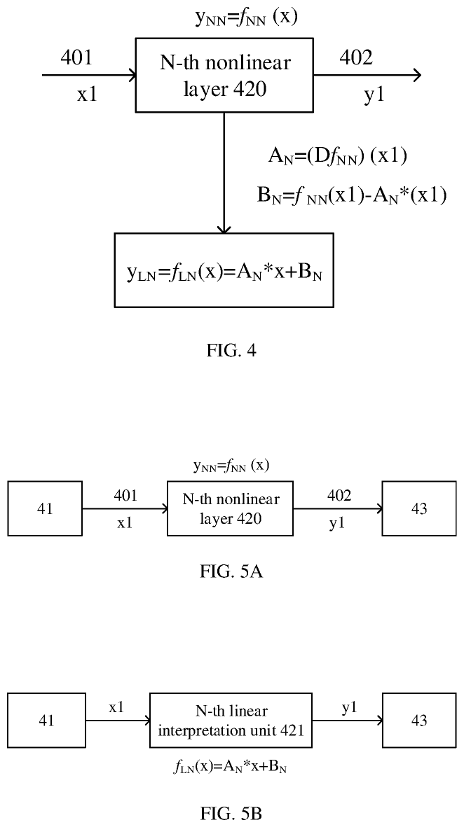

FIG. 3 is a flowchart of a processing method of a neural network provided by some embodiments of the present disclosure, and FIG. 4 is a schematic diagram of a nonlinear layer and a linear function corresponding to the nonlinear layer provided by some embodiments of the present disclosure.

For example, the neural network is a nonlinear system, and the neural network includes at least one nonlinear layer. As shown in FIG. 3, the processing method of the neural network provided by some embodiments of the present disclosure includes the following steps.

S11: processing an input matrix input to N-th nonlinear layer in the at least one nonlinear layer by using the N-th nonlinear layer to obtain an output matrix output by the N-th nonlinear layer.

S12: according to the input matrix and the output matrix, performing linearization processing on the N-th nonlinear layer to determine an expression of an N-th linear function corresponding to the N-th nonlinear layer.

For example, the neural network may be a convolution neural network. At least one nonlinear layer includes an activation layer, an instance normalization layer, a maximum pooling layer, a softmax layer, and the like. For example, the activation function of the activation layer can be a ReLU function, a tanh function, or a sigmoid function. The embodiments of the present disclosure will be described in detail below by taking the case that the N-th nonlinear layer is the activation layer and the activation function of the activation layer is the ReLU function as an example, but the embodiments of the present disclosure are not limited to the case of the activation layer.

For example, N is a positive integer and is less than or equal to the amount of all nonlinear layers in the neural network. In some embodiments, the neural network includes M nonlinear layers, where M is a positive integer, then 1≤N≤M. It should be noted that although the embodiments of this present disclosure are described in detail by taking the N-th nonlinear layer as an example, the processing method provided by the embodiments of the present disclosure is applicable to every nonlinear layer in the neural network.

For example, in step S11, the input matrices input to different nonlinear layers may be the same or different. For example, the neural network includes a first nonlinear layer and a second nonlinear layer, the first nonlinear layer and the second nonlinear layer may be different. The first input matrix is the input of the first nonlinear layer, and the second input matrix is the input of the second nonlinear layer. For example, each element and size of the first input matrix are the same as the element and size of the second input matrix, respectively. The first input matrix and the second input matrix may also be different. For example, the size of the first input matrix and the size of the second input matrix may be different, and at least some elements of the first input matrix are different from at least some elements of the second input matrix.

For example, the output matrices of different nonlinear layers are different.

For example, in some embodiments, as shown in FIG. 4, the N-th nonlinear function corresponding to the N-th nonlinear layer 420 can be expressed as: y_{NN}=f_{NN}(x), where x represents the input of the N-th nonlinear layer 420. Different nonlinear layers have different functional expressions. For example, in a case where the N-th nonlinear layer 420 is an activation layer and the activation function in the activation layer is a ReLU function, the expression of the nonlinear function corresponding to the N-th nonlinear layer 420 can be expressed as:

y_{NN}=f_{NN} (x)=max(x>0, x, 0).

For another example, in the case where the N-th nonlinear layer 420 is an activation layer and the activation function in the activation layer is a Sigmoid function, the expression of the nonlinear function corresponding to the N-th nonlinear layer 420 is expressed as:

$${y}_{N N} = {f}_{N N} ( x ) = \frac{1}{1 + {e}^{x}} .$$

For example, in some embodiments, in step S11, the input matrix 401 is an input matrix input to the N-th nonlinear layer, that is, the input matrix 401 is input to the N-th nonlinear layer 420. The N-th nonlinear layer 420 performs corresponding processing (e.g., activation processing) on the input matrix 401 to obtain an output matrix 402, so that the output matrix 402 is the output matrix output by the N-th nonlinear layer 420. As shown in FIG. 4, x1 represents the input matrix 401 and y1 represents the output matrix 402, and then y1=f_{NN}(x1).

For example, both the input matrix 401 and the output matrix 402 can be two-dimensional matrices, and the size of the input matrix 401 is the same as the size of the output matrix 402. The value of a point located in an i-th row and a j-th column in the input matrix 401 are expressed as x1ᵢⱼ, and the value of a point located in the i-th row and the j-th column in the output matrix 402 are expressed as y1ᵢⱼ, where i and j are positive integers, 0<i≤Q1, 0<j≤Q2, Q1 and Q2 are positive integers, Q1 represents the total amount of rows in the input matrix 401, and Q2 represents the total amount of columns in the input matrix 401. For example, in the case where the N-th nonlinear layer 420 is an activation layer and the activation function in the activation layer is a ReLU function, y1ᵢⱼ=max(x1_{i,j}>0, x1ᵢⱼ, 0).

For example, the nonlinear activation including a ReLU function corresponds to Taylor expansion for the input of the nonlinear layer. For example, based on the input matrix 401, Taylor expansion is performed on the nonlinear function corresponding to the N-th nonlinear layer 420 to determine the Taylor expansion expression of the N-th nonlinear layer 420. For example, the Taylor expansion expression of the N-th nonlinear layer 420 is:

$$\begin{matrix}{f}_{N N} ( x ) = {f}_{N N} ( x 1 ) + ( D f ) ( x 1 ) \cdot ( x - x 1 ) + … = \\ ( Df ) ( x 1 ) \cdot x + {f}_{N N} ( x 1 ) - ( D f ) ( x 1 ) \cdot x 1 …\end{matrix} .$$

It should be noted that the higher-order terms of the above Taylor expansion expression are all nonlinear, and in order to linearize the nonlinear layer, the higher-order terms of the Taylor expansion expression can be omitted at x1, so that the linear function expression corresponding to the N-th nonlinear layer 420 can be obtained.

For example, in step S12, the N-th linear function corresponding to the N-th nonlinear layer 420 includes a first parameter and a second parameter. The expression of the N-th linear function is expressed as:

y_{LN}=f_{LN}=A_{N}*x+B_{N}.

where f_{LN} represents the N-th linear function, A_{N} represents the first parameter of the N-th linear function, B_{N} represents the second parameter of the N-th linear function, x represents the input of the N-th nonlinear layer, and as shown in FIG. 4, A_{N} and B_{N} are determined according to the input matrix 401 and the output matrix 402.

It should be noted that the N-th linear function is determined based on the N-th nonlinear layer and the input matrix input to the N-th nonlinear layer. In the case where the N-th nonlinear layer is fixed and the input matrices input to the N-th nonlinear layer are different, the first parameters and the second parameters in the N-th linear function are different. In the case where the input matrices input to the N-th nonlinear layer are the same and the N-th nonlinear layer is a different type of nonlinear layer, that is, the input matrices are input to different nonlinear layers, the first parameters and the second parameters in the N-th linear function are also different. That is to say, different linear functions can obtained by inputting different input matrices into the same nonlinear layer; different linear functions can be obtained by inputting the same input matrix into different nonlinear layers.

For example, as shown in FIG. 4, the operation performed by the linear system based on the N-th linear function is similar to the operation performed by the N-th nonlinear layer 420, that is, within an acceptable slight error range, it can be considered that the operation performed by the linear system based on the N-th linear function is the same as the operation performed by the N-th nonlinear layer 420, so that the N-th nonlinear layer 420 can be replaced by the linear system in the form of f_{LN}=A_{N}*x+B_{N}.

For example, the first parameter A_{N} and the second parameter B_{N} may be constants. In some examples, the first parameter A_{N} and the second parameter B_{N} are both matrices, and all values in the matrix are constants. In other embodiments, the first parameter A_{N} and the second parameter B_{N} are both constants; in yet other embodiments, one of the first parameter A_{N} and the second parameter B_{N} is a matrix and the other of the first parameter A_{N} and the second parameter B_{N} is a constant.

For example, according to the above Taylor expansion expression, the expression of the first parameter A_{N} of the N-th linear function can be expressed as:

A_{N}=(Df_{NN}) (x1),

where Df_{NN} represents the first derivative of the nonlinear function corresponding to the N-th nonlinear layer 420 at x1, and x1 represents the input matrix 401.

For example, according to the above Taylor expansion expression, the expression of the second parameter B_{N} of the N-th linear function can be expressed as:

B_{N}=f_{NN} (x1)−(Df_{NN}) (x1)*(x1)=f_{NN} (x1)−A_{N}*(x1),

where f_{NN} represents the nonlinear function corresponding to the N-th nonlinear layer 420, and f_{NN} (x1) represents the output matrix 402.

For example, in the case where the N-th nonlinear layer 420 is an activation layer and the activation function in the activation layer is a ReLU function, the first parameter A_{N} of the N-th linear function is 1 or 0, and the second parameter B_{N} of the N-th linear function is 0.

FIG. 5A is a schematic diagram of a partial structure of a neural network provided by some embodiments of the present disclosure, and FIG. 5B is a schematic diagram of a partial structure of a modified neural network provided by some embodiments of the present disclosure.

For example, the neural network also includes convolution layers. As shown in FIG. 5A, in some embodiments, the neural network includes a first convolution layer 41, an N-th nonlinear layer 420, and a second convolution layer 43, and the first convolution layer 41, the N-th nonlinear layer 420 and the second convolution layer 43 are sequentially connected. The N-th nonlinear layer 42 may be an activation layer. For example, the input matrix 401 may be the output of the first convolution layer 41, that is, the first convolution layer 41 outputs the input matrix 401, and the N-th nonlinear layer 420 processes the input matrix 401 to obtain the output matrix 402. The output matrix 402 is the input of the second convolution layer 43. For example, in the example shown in FIG. 5A, both the input matrix 401 and the output matrix 402 may be feature images.

It should be noted that the neural network can also include an average pooling layer, a full connection layer, and so on.

For example, after performing linearization processing on the N-th nonlinear layer, an N-th linear interpretation unit corresponding to the N-th nonlinear layer can be determined, and the modified neural network can be obtained by replacing the N-th nonlinear layer with the N-th linear interpretation unit. As shown in FIG. 5B, the modified neural network includes a first convolution layer 41, an N-th linear interpretation unit 421, and a second convolution layer 43. The N-th linear interpretation unit 421 corresponds to the N-th nonlinear layer 420 in FIG. 5A, and the N-th nonlinear layer 420 in the neural network shown in FIG. 5A is replaced by the N-th linear interpretation unit 421 to obtain the modified neural network shown in FIG. 5B. The functional expression corresponding to the N-th linear interpretation unit 421 is the N-th linear function, that is, f_{LN}=A_{N}*x+B_{N}. The structure, parameters, etc. of the first convolution layer 41 and the structure, parameters, etc. of the second convolution layer 43 remain unchanged.

For example, as shown in FIGS. 5A and 5B, the N-th linear interpretation unit 421 and the N-th nonlinear layer 420 can perform similar operations, that is, for the same input matrix x1, after the input matrix x1 is input to the N-th nonlinear layer 420, the output matrix y1 is obtained; after the input matrix x1 is input to the N-th linear interpretation unit 421, the output matrix y1 can also be obtained.

For example, for the activation layer whose activation function is ReLU, a linear interpretation unit with a binary mask function can be used to replace the activation layer. For the activation layer whose activation function is sigmoid, a linear interpretation unit with a continuous mask function can be used to replace the activation layer. For the maximum pooling layer, a linear interpretation unit with a non-uniform downsampling function can be used to replace the maximum pooling layer. For the instance normalization layer, a linear interpretation unit with a linear normalization function can be used to replace the instance normalization layer.

For example, in some embodiments, the processing method of the neural network can also comprises performing linearization processing on all nonlinear layers in the neural network to determine the expressions of linear functions respectively corresponding to the all nonlinear layers, so as to obtain linear interpretation units respectively corresponding to the all nonlinear layers, and thus determine the linearized neural network corresponding to the neural network. For the process of the linearization processing of each nonlinear layer of the neural network, reference can be made to the above-mentioned related description of step S11 and step S12. For example, after performing linearization processing on all nonlinear layers in the neural network, linear interpretation units that are in one-to-one correspondence to all nonlinear layers in the neural network can be determined, and then all nonlinear layers in the neural network are replaced by corresponding linear interpretation units, that is, all nonlinear layers in the neural network are replaced by corresponding linear interpretation units, respectively, thus obtaining a linearized neural network. For example, all nonlinear layers in the neural network correspond to all linear interpretation units in the linearized neural network in one-to-one correspondence manner. Therefore, the linear interpretation unit is used to explain the operation (for example, activation operation) of the nonlinear layer, and the linearized neural network is a linear system, so that the linearized neural network can be used to analyze and evaluate the neural network. It is worth noting that in the present disclosure, the “neural network” is a nonlinear system, that is, the “neural network” includes a nonlinear layer and a linear layer; the “linearized neural network” is a linear system, that is, the “linearized neural network” includes a linear interpretation unit and a linear layer. The linear interpretation unit is not an actual layer structure in neural network, but a layer structure defined for convenience of description.

It should be noted that it is also possible to only replace some nonlinear layers in the neural network with corresponding linear interpretation units. For example, all activation layers in the neural network are replaced by linear interpretation units corresponding to the activation layers, and all instance normalization layers in the neural network are replaced by linear interpretation units corresponding to the instance normalization layers, while the maximum pooling layer and softmax layer in the neural network remain unchanged.

For example, in some embodiments, the whole neural network can be equivalent to a linear interpretation unit. In this case, the processing method of the neural network includes the following steps: processing the input image by the neural network to obtain the output image; according to the input image and the output image, determining the linear interpretation unit corresponding to the neural network. The input image can be various types of images, for example, the input image can be an image captured by an image acquisition device, such as a digital camera or a mobile phone, and the embodiments of the present disclosure are not limited to this case.

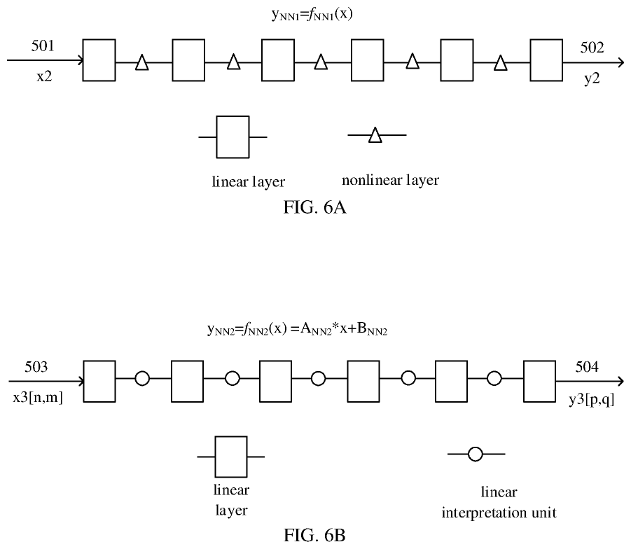

FIG. 6A is a structural schematic diagram of a neural network provided by some embodiments of the present disclosure, and FIG. 6B is a structural schematic diagram of a linearized neural network provided by some embodiments of the present disclosure.

For example, as shown in FIG. 6A, in some embodiments, the neural network can be equivalent to a nonlinear system, and the functional expression of the nonlinear system is: y_{NN1}=f_{NN1} (x), where x represents the input of the neural network, for example, x represents an input image, y_{NN1} is a nonlinear function, for example, y_{NN1} can be a high-order polynomial expression of x. The neural network shown in FIG. 6A may include five linear layers and five nonlinear layers, and each nonlinear layer is located between two adjacent linear layers.

For example, in the case where all nonlinear layers in the neural network are replaced by linear interpretation units, a linearized neural network as shown in FIG. 6B can be obtained. As shown in FIG. 6B, the linearized neural network includes five linear layers and five linear interpretation units, the five linear interpretation units are in one-to-one correspondence to the five nonlinear layers shown in FIG. 6A. The linearized neural network is a linear system, and the expression of the linear function corresponding to the linearized neural network is as follows: y_{NN2}=f_{NN2} (x)=A_{NN2}*x+B_{NN2}, where A_{NN2} and B_{NN2} are parameters of the linear function corresponding to the linearized neural network, and both are constant terms.

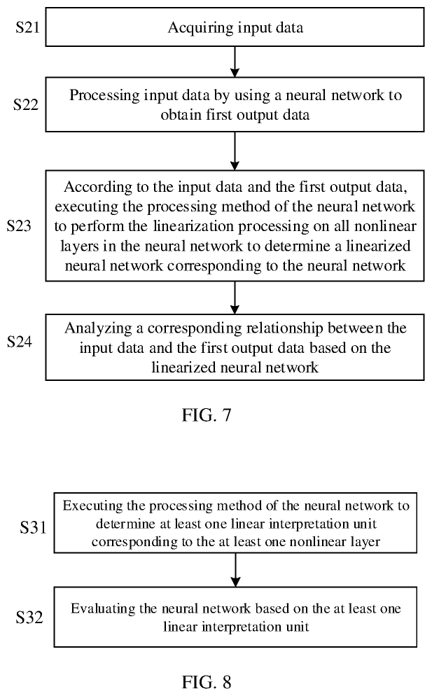

FIG. 7 is a flowchart of a data analysis method based on neural network provided by some embodiments of the present disclosure.

For example, the neural network can be a linearized neural network obtained after being processed by the above processing method of the neural network. As shown in FIG. 7, the data analysis method provided by some embodiments of the present disclosure includes the following steps.

S21: acquiring input data;

S22: processing input data by using a neural network to obtain first output data;

S23: according to the input data and the first output data, executing the processing method of the neural network to perform the linearization processing on all nonlinear layers in the neural network to determine a linearized neural network corresponding to the neural network;

S24: analyzing a corresponding relationship between the input data and the first output data based on the linearized neural network.

In the data analysis method provided by some embodiments of the present disclosure, because the linearized neural network is a linear system, the processing process of the neural network on various data can be analyzed based on the linear system, and the visualization of the neural network can be achieved.

Linear systems can be fully described by impulse response. Because the linearized neural network is a linear system, the impulse response can be performed on the linearized neural network to analyze the linearized neural network. In the case of analyzing the processing process of the linearized neural network on an image, the impulse response can show the influence of input pixels in the input image on output pixels in the output image. For example, after processing the input image by the linearized neural network, the conversion relationship between respective input pixels and respective output pixels can be determined, for example, which input pixels are used to obtain the output pixels, and the proportion of each input pixel. According to the standard method of the linear system, the opposite relationship, that is, the influence of output pixels on input pixels, can also be obtained, for example, which input pixels a certain output pixel corresponds to, etc. When analyzing the processing process of a certain nonlinear layer in the linearized neural network on the input matrix, similarly, impulse response can show the influence of input elements in the input matrix on output elements in the output matrix.

The data analysis methods provided by some embodiments of the present disclosure can be applied to image recognition, image classification, speech recognition, speech classification, and other fields.

For example, in step S21 and step S22, the input data and the first output data may be images, texts, speeches, etc. For example, in the case where the input data and the first output data are images, the input data and the first output data may be two-dimensional matrices; in the case where the input data and the first output data are texts or speeches, the input data and the first output data may be one-dimensional matrices.

For example, as shown in FIG. 6A, in some embodiments, the neural network processes the input data 501 to obtain the first output data 502. The input data 501 is denoted as x2, and the first output data 502 is denoted as y2, so y2=f_{NN1}(x2).

For example, in step S23, the processing method of the neural network is the processing method provided according to any of the above embodiments of the present disclosure. For a detailed description of performing linearization processing on all nonlinear layers in the neural network, please refer to the relevant description of steps S11-S12 in the above processing method of the neural network, and the repetition is not repeated here.

It should be noted that in step S23, the linearized neural network is determined based on the input data and the neural network. In the case where the structure and parameters of the neural network are fixed and the input data input into the neural network are different, different linearized neural networks can be obtained. In the case where the input data are the same, but the structure and parameters of the neural networks are different, that is, in the case where the input data are input to different neural networks, different linearized neural networks can also be obtained. That is to say, different linearized neural networks can be obtained by inputting different input data into the same neural network; and different linearized neural networks can be obtained by inputting the same input data into different neural networks.

For example, step S24 may include determining a detection data group according to the input data, the detection data group being a binary matrix group; processing the detection data group by using the linearized neural network to obtain a second output data group; and analyzing a positive influence or a negative influence between the input data and the first output data based on the detection data group and the second output data group.

For example, “positive influence” means the influence of each input element in the input data on each output element in the first output data, for example, which output elements in the first output data each input element can correspond to, etc.; “negative influence” means the influence of each output element in the first output data on each input element in the input data, for example, which input elements in the input data each output element can correspond to, etc.

For example, the amount and sizes of detection data in the detection data group can be determined according to the input data. The size of each detection data is the same as the size of the input data.

For example, in some embodiments, the detection data group includes at least one detection data, the second output data group includes at least one second output data, and the at least one detection data is in one-to-one correspondence to the at least one second output data. For example, if the detection data group can include three detection data, then the second output data group includes three second output data, a first detection data corresponds to a first second output data, a second detection data corresponds to a second second output data, and a third detection data corresponds to a third second output data.

For example, each detection data is a binary matrix. It should be noted that the binary matrix indicates that a value of an element in the binary matrix is 1 or 0.

In the present disclosure, “impulse response” means the output (e.g., second output data) of an input (e.g., detection data), a value of a certain pixel (e.g., target detection element) in the detection data is 1, and the values of all other elements (e.g., non-target detection elements) are 0.

For example, the detection data and the second output data may also be images, texts, speeches, etc. For example, in the case where the detection data and the second output data are images, the detection data and the second output data may be two-dimensional matrices; in the case where the detection data and the second output data are texts or speeches, the detection data and the second output data may be one-dimensional matrices.

For example, in the case where the input data is an image, the input elements in the input data represent pixels in the image; in the case where the input data is text, the input elements in the input data represent Chinese characters or letters in the text data; in the case where the input data is speech, the input elements in the input data represent the phonemes in the speech data. It should be noted that the above description takes the input data as an example to explain the elements in the data, and the above description is equally applicable to the first output data, the detection data, and the second output data.

For example, in step S24, based on the detection data group and the second output data group, analyzing the positive influence between the input data and the first output data includes: processing the at least one detection data by using the linearized neural network, respectively, to obtain the at least one second output data; and determining the positive influence of respective input elements of the input data on respective output elements of the first output data by analyzing a corresponding relationship between the at least one detection data and the at least one second output data at an element level.

For example, each detection data includes a target detection element, the value of the target detection element is one, all other detection elements except the target detection element in each detection data are non-target detection elements, and values of the non-target detection elements are 0.

For example, as shown in FIG. 6B, in some embodiments, the detection data group includes detection data 503 and the second output data group includes second output data 504, the detection data 503 is denoted as x3[n, m], the second output data 504 is denoted as y3[p, q, and the detection data 503 corresponds to the second output data 504]. In some examples, the element located in a n0-th row and a m0-th column in the detection data 503 is the target detection element, and the other elements in the detection data 503 are all non-target detection elements, so the detection data 503 can be expressed as:

$$x 3 [ n , m ] = \{ \begin{matrix}1 & if n = n 0 , m = m 0 \\ 0 & others\end{matrix} ,$$

where n, m, n0, and m0 are positive integers, and 0<n≤Q3, 0<m≤Q4, Q3 and Q4 are positive integers, Q3 represents the total amount of rows of the detection data 503, and Q4 represents the total amount of columns of the detection data 503. For example, the size of the input data 501 and the size of the detection data 503 are the same.

For example, as shown in FIG. 6B, the expression of the linear function corresponding to the linearized neural network is: y_{NN2}=f_{NN2}(x)=A_{NN2}*x+B_{NN2}, so the second output data 504 is expressed as:

y3[p, q]=A_{NN2}*x3[n, m]+B_{NN2},

where y3[p, q] represents the second output data 504, p and q are positive integers, 0<p≤Q5, 0<q≤Q6, Q5 and Q6 are positive integers, Q5 represents the total amount of rows of the second output data 504 and Q6 represents the total amount of columns of the second output data 504. For example, the size of the second output data 504 and the size of the first output data 502 may be the same.

For example, because the target detection element in the detection data 503 is located at the n0-th row and m0-th column, the contribution, that is, the positive influence, of the detection element located at the n0-th row and m0-th column in the detection data 503 to each output element in the second output data 504 can be determined according to the detection data 503 and the second output data 504.

It should be noted that in the embodiment of the present disclosure, the size of the one-dimensional matrix represents the amount of elements in the one-dimensional matrix; the size of the two-dimensional matrix indicates the amount of rows and the amount of columns in the two-dimensional matrix. For example, in the case where both the input data 501 and the detection data 503 are two-dimensional matrices, “the size of the input data 501 is the same as the size of the detection data 503” can mean that the amount of rows of the input data 501 and the amount of rows of the detection data 503 are the same, and the amount of columns of the input data 501 and the amount of columns of the detection data 503 are the same. In the case where both the input data 501 and the detection data 503 are one-dimensional matrices, “the size of the input data 501 is the same as the size of the detection data 503” can mean that the amount of elements in the input data 501 is the same as the amount of elements in the detection data 503.

For example, the second parameter B_{NN2} can represent the output obtained after the linearized neural network processes the all-zero matrix, and the second parameter B_{NN2} can represent a bias coefficient.

In the detection data 503, only the value of the element located in the n0-th row and m0-th column is 1, and the values of the other elements in the detection data 503 are 0. Therefore, by analyzing the corresponding relationship between the detection data 503 and the second output data 504 at the element level, the contribution of the input element located in the n0-th row and m0-th column in the input data 501 to all output elements in the first output data 502 can be obtained.

For example, in the case where the detection data group includes a plurality of detection data, the positions of target detection elements in at least part detection data among the plurality of detection data are different. For example, in some embodiments, the input data 501 includes Q3*Q4 input elements, and the detection data group may include Q3*Q4 detection data, the target detection element in each detection data correspond to one input element in the input data 501, and the positions of Q3*Q4 target detection elements in the Q3*Q4 detection data are in one-to-one correspondence to the positions of Q3*Q4 input elements in the input data 501, respectively. That is to say, if the target detection element of one detection data is located in the first row and first column, the target detection element of the detection data corresponds to the input element located in the first row and first column in the input data. By analyzing the detection data and the second output data corresponding to the detection data, the contribution of the input element located in the first row and first column in the input data 501 to each output element in the first output data 502 can be determined.

For example, by analyzing Q3*Q4 detection data, the contribution of each input element in the input data 501 to respective output elements in the first output data 502 can be determined. However, the present disclosure is not limited to this case. According to actual application requirements, only part of the input elements in the input data 501 can be analyzed. In this case, only the detection data corresponding to the input elements that needs to be analyzed in the input data 501 can be stored and analyzed, thereby saving the storage space and system resources.

For example, the plurality of detection data have the same size.

It should be noted that in the above description, a case where only one target detection element is included in the detection data is taken as an example to illustrate the embodiments of the present disclosure, that is, to the positive influence of a certain specific input element in the input data (for example, the input element located in the n0-th row and m0-th column) on the output is analyzed, but the embodiments of the present disclosure are not limited to this case. It is also possible to analyze the positive influence of a plurality of specific input elements in the input data on the output, so that each detection data may include a plurality of target detection elements (for example, two target detection elements, three target detection elements, etc.), and the values of the plurality of target detection elements are all 1. Except for the plurality of target detection elements, the values of other elements in the detection data are all 0.

For example, in other embodiments, the detection data group includes a plurality of detection data, the second output data group includes a plurality of second output data, and the plurality of detection data are in one-to-one correspondence to the plurality of second output data, and each detection data is a binary matrix. The plurality of detection data has the same size.

In this case, in step S24, analyzing the negative influence between the input data and the first output data based on the detection data group and the second output data group, includes: processing the plurality of detection data by using the linearized neural network, respectively, to obtain the plurality of second output data; and determining the negative influence of respective output elements of the output data on respective input elements of the input data by analyzing a corresponding relationship between the plurality of detection data and the plurality of second output data at an element level.

For example, each detection data includes a target detection element, a value of the target detection element is 1, and all other detection elements except the target detection element in each detection data are non-target detection elements, values of the non-target detection elements are 0. The amount of the plurality of detection data in the detection data group is the same as the amount of elements in each detection data, and the positions of target detection elements of any two detection data in the plurality of detection data are different.

For example, the input data 501 includes a plurality of input elements, the plurality of detection data includes a plurality of target detection elements, and the plurality of input elements are in one-to-one correspondence to the plurality of target detection elements. That is to say, if the input matrix 501 includes Q3*Q4 input elements, the detection data group may include Q3*Q4 detection data, the target detection element in each detection data correspond to one input element in the input data 501, and the positions of the Q3*Q4 target detection elements in the Q3*Q4 detection data are in one-to-one correspondence to the positions of the Q3*Q4 input elements in the input data 501.

When analyzing the negative influence, that is, when analyzing the influence of the first output data 502 on the input data 501, if analyzing how the first output data 502 is influenced by the input data 501, for a specific output element in the first output data 502, because it is unclear that the specific output element is obtained from one or several input elements in the input data 501, the plurality of detection data that are in one-to-one correspondence to all input elements in the input data 501 can be input to analyze the influence of all input elements in the input data 501 on the specific output element.

To sum up, the detection data can be input into the linearized neural network, and the relationship between the input detection data and the corresponding second output data can be analyzed at the element level to obtain the positive or negative influence between the input data and the first output data, so as to analyze the specific processing process of the input data by the nonlinear layer in the neural network, determine which input elements in the input data determine a specific output element of the first output data (negative influence), and determine the contribution of each input element in the input data to a specific output element of the first output data (positive influence).

It should be noted that the data analysis method provided by the embodiment of the present disclosure is described above by taking a case of analyzing the processing procedure of the neural network as an example, but the present disclosure is not limited to this case. In some examples, the data processing process of a certain nonlinear layer in the neural network can be analyzed, and the data processing process of the nonlinear layer is similar to the process of the above data analysis method, so the repetitions are not repeated here.

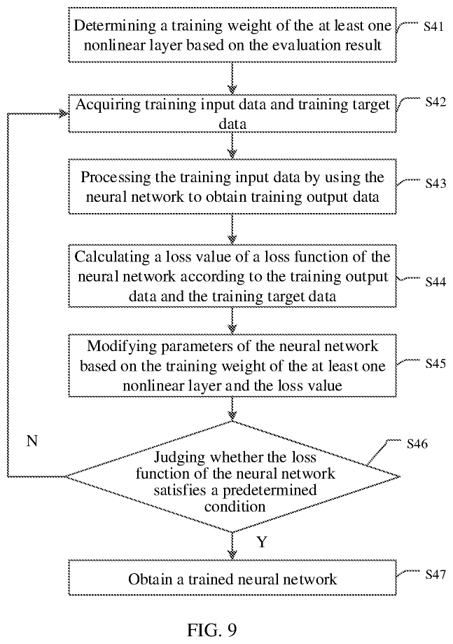

FIG. 8 is a flowchart of an evaluation method of a neural network provided by some embodiments of the present disclosure; FIG. 9 is a flowchart of a training method of a neural network provided by some embodiments of the present disclosure.

For example, as shown in FIG. 8, the evaluation method of the neural network provided by some embodiments of the present disclosure may include the following steps.

S31: executing the processing method of the neural network to determine at least one linear interpretation unit corresponding to the at least one nonlinear layer;

S32: evaluating the neural network based on the at least one linear interpretation unit.

For example, in step S31, the processing method of the neural network is the processing method provided according to any of the above embodiments of the present disclosure. For a detailed description of performing linearization processing on at least one nonlinear layer in the neural network, please refer to the relevant description of steps S11-S12 in the above processing method of the neural network, and the repetition is not repeated here.

For example, in step S31, all nonlinear layers in the neural network can be linearized to obtain a plurality of linear interpretation units, which are in one-to-one correspondence to all nonlinear layers in the neural network.

For example, in some embodiments, step S32 may include: evaluating the at least one linear interpretation unit to determine an evaluation result of the at least one nonlinear layer; and training the neural network based on the evaluation result.

For example, in step S32, the detection data may be input to the at least one linear interpretation unit to obtain the second output data. By analyzing the relationship between the detection data and the second output data, the positive or negative influence between the input data and the first output data is obtained, so as to determine the evaluation result of the at least one nonlinear layer, and then determine the contribution degree of each nonlinear layer in the neural network to the input.

For example, as shown in FIG. 9, in some embodiments, training the neural network based on the evaluation result includes the following step.

S41: determining a training weight of the at least one nonlinear layer based on the evaluation result;

S42: acquiring training input data and training target data;

S43: processing the training input data by using the neural network to obtain training output data;

S44: calculating a loss value of a loss function of the neural network according to the training output data and the training target data;

S45: modifying parameters of the neural network based on the training weight of the at least one nonlinear layer and the loss value;

S46: judging whether the loss function of the neural network satisfies a predetermined condition.

In the case where the loss function of the neural network satisfies the predetermined condition, step S47 is executed, that is, obtaining a trained neural network.

In the case where the loss function of the neural network does not satisfy the predetermined condition, return to step S42, and continue to input training input data and training target data to repeatedly execute the above training process.

For example, in step S41, in the case where all nonlinear layers in the neural network are linearized to obtain a plurality of linear interpretation units that are in one-to-one correspondence to all nonlinear layers in the neural network, all nonlinear layers in the neural network can be evaluated according to the plurality of linear interpretation units to determine the training weights of all nonlinear layers in the neural network. It should be noted that, in step S41, it is also possible to perform linearization processing on only part of the nonlinear layers in the neural network, so that in the training process, the training weights of this part of the nonlinear layers may be determined.

For example, in step S41, the contribution degree (i.e., weight) of each linear interpretation unit to the input can be analyzed based on the impulse response, so as to determine the contribution degree (i.e., weight) of each nonlinear layer in the neural network to the input data in the process of processing the input data through the neural network, determine how to ameliorate the amount of filters and parameters of the neural network, and optimize the network configuration. It should be noted that the contribution degree (i.e., weight) of each linear layer in the neural network to the input data can also be analyzed based on impulse response. For example, a layer (nonlinear layer and/or linear layer) with low contribution can be directly removed, thus reducing the complexity of the neural network and reducing the amount of data in the process of training the neural network; or, in the training process, in step S45, the parameters of the layer with lower contribution may not be corrected. For the layer with higher contribution (nonlinear layer and/or linear layer), the layer with higher contribution can be trained emphatically in the training process, that is, in the training process, in step S45, the parameters of the layer with higher contribution are adjusted to make the layer with higher contribution optimal.

For example, in step S45, the training target data can be taken as the target value of the training output data, and the parameters of the neural network can be continuously optimized to finally obtain a trained neural network.

For example, in step S46, in an example, the predetermined condition corresponds to the loss convergence of the loss function of the neural network in the case where a certain amount of the training input data and training target data are input. In another example, the predetermined condition is that the amount of training times or training periods of the neural network reaches a predetermined amount, and the predetermined amount can be millions as long as the set of training input data and training target data is large enough.

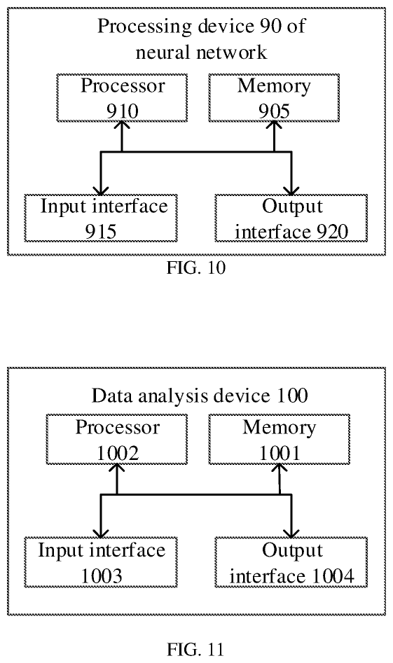

FIG. 10 is a schematic diagram of a processing device of a neural network according to some embodiments of the present disclosure. As shown in FIG. 10, the processing device 90 of the neural network may include a memory 905 and a processor 910. The memory 905 is used to store computer-readable instructions. The processor 910 is used to execute the computer-readable instructions, and when the computer-readable instructions are executed by the processor 910, the processing method of the neural network according to any of the above embodiments can be executed. For example, the neural network includes at least one nonlinear layer, and when the computer-readable instructions are executed by the processor 910, the following operations can be performed: processing an input matrix input to an N-th nonlinear layer in the at least one nonlinear layer by using the N-th nonlinear layer to obtain an output matrix output by the N-th nonlinear layer; and according to the input matrix and the output matrix, performing linearization processing on the N-th nonlinear layer to determine an expression of an N-th linear function corresponding to the N-th nonlinear layer.

For example, the expression of the N-th linear function is expressed as:

f_{LN}=A_{N}*x+B_{N},

where f_{LN} represents the N-th linear function, A_{N} represents the first parameter of the N-th linear function, B_{N} represents the second parameter of the N-th linear function, x represents the input of the N-th nonlinear layer, and A_{N} and BN are determined according to the input matrix and output matrix corresponding to the N-th nonlinear layer, where N is a positive integer.

For example, the processor 910 may be a central processing unit (CPU), a tensor processor (TPU), or a device having data processing capability and/or program execution capability, and may control other components in the processing device 90 of the neural network to perform desired functions. The central processing unit (CPU) can be X86 or ARM architecture.

For example, the memory 905 may include one or more computer program products, and the computer program products may include various forms of computer-readable storage media, such as volatile memory and/or nonvolatile memory. The volatile memory may include random access memory (RAM) and/or cache, for example. The nonvolatile memory may include, for example, a read-only memory (ROM), a hard disk, an erasable programmable read-only memory (EPROM), a portable compact disk read-only memory (CD-ROM), a USB memory, a flash memory, and the like. One or more computer-readable instructions can be stored on the computer-readable storage medium, and the processor 910 can execute the computer-readable instructions to achieve various functions of the processing device 90 of the neural network.

For example, as shown in FIG. 10, the processing device 90 of the neural network further includes an input interface 915 that allows external devices to communicate with the processing device 90 of the neural network. For example, the input interface 915 may be used to receive instructions from an external computer device, a user, and the like. The processing device 90 of the neural network may also include an output interface 920 that connects the processing device 90 of the neural network with one or more external devices. For example, the processing device 90 of the neural network can output the first parameter and the second parameter of the linear function corresponding to the nonlinear layer through the output interface 920. It is considered that the external device that communicates with the processing device 90 of the neural network through the input interface 915 and the output interface 920 can be included in an environment that provides essentially any type of user interface with which a user can interact. Examples of types of the user interface include a graphical user interface, a natural user interface, and the like. For example, the graphical user interface can accept input from a user using an input device, such as a keyboard, a mouse, a remote controller, etc., and can provide the output on an output device, such as a display. In addition, a natural language interface may enable the user to interact with the processing device 90 of the neural network in a manner without being constrained by the input devices, such as a keyboard, a mouse, a remote controller, and the like. On the contrary, the natural user interface can rely on speech recognition, touch and stylus recognition, gesture recognition on and near the screen, aerial gesture, head and eye tracking, voice and speech, vision, touch, gesture, machine intelligence, and the like.

For example, data transmission can be implemented between the memory 905 and the processor 910 through a network or bus system. The memory 905 and the processor 910 can communicate with each other directly or indirectly.

It should be noted that the detailed description of the processing procedure of the processing method of the neural network performed by the processing device 90 of the neural network can refer to the relevant description in the embodiments of the processing method of the neural network, and the repetition is not repeated here.

FIG. 11 is a schematic diagram of a data analysis device according to some embodiments of the present disclosure. For example, as shown in FIG. 11, the data analysis device 100 can implement the data analysis process based on the neural network, and the data analysis device 100 can include a memory 1001 and a processor 1002. The memory 1001 is used to store computer-readable instructions. The processor 1002 is use to execute the compute readable instructions, and in the case where the computer-readable instructions are executed by the processor 1002, the data analysis method according to any of the above embodiments can be executed. For example, when the computer-readable instructions are executed by the processor 1002, the following operations are performed: acquiring input data; processing the input data by using the neural network to obtain first output data; according to the input data and the first output data, executing the processing method of the neural network according to any one of the above embodiments, and performing the linearization processing on all nonlinear layers in the neural network to determine a linearized neural network corresponding to the neural network; and based on the linearized neural network, analyzing a corresponding relationship between the input data and the first output data.

For example, in addition to storing the computer-readable instructions, the memory 1001 may also store training input data, training target data, and the like.

For example, the processor 1002 may be a central processing unit (CPU), a tensor processor (TPU), a graphics processor (GPU), and other devices with data processing capability and/or program execution capability, and may control other components in the data analysis device 100 to perform desired functions. The central processing unit (CPU) can be X86, ARM architecture, or the like. The GPU can be directly integrated into the main board or built into the north bridge chip of the main board. The GPU can also be built into the central processing unit (CPU).

For example, the memory 1002 may include one or more computer program products, and the computer program products may include various forms of computer-readable storage media, such as volatile memory and/or nonvolatile memory. The volatile memory may include random access memory (RAM) and/or cache, for example. The nonvolatile memory may include, for example, a read-only memory (ROM), a hard disk, an erasable programmable read-only memory (EPROM), a portable compact disk read-only memory (CD-ROM), a USB memory, a flash memory, and the like. One or more computer-readable instructions can be stored on the computer-readable storage medium, and the processor 1002 can execute the computer-readable instructions to achieve various functions of the data analysis device 100.

For example, data transmission between the memory 1001 and the processor 1002 can be implemented through a network or bus system. The memory 1001 and the processor 1002 can communicate with each other directly or indirectly.

For example, as shown in FIG. 11, the data analysis device 100 further includes an input interface 1003 that allows external devices to communicate with the data analysis device 100. For example, the input interface 1003 can be used to receive instructions from an external computer device, a user, and the like. The data analysis device 100 may also include an output interface 1004 that connects the data analysis device 100 with one or more external devices. For example, the data analysis device 100 can output analysis results and the like through the output interface 1004. It is considered that the external device that communicates with the data analysis device 100 through the input interface 1003 and the output interface 1004 can be included in an environment that provides essentially any type of user interface with which users can interact. Examples of types of the user interface include graphical user interfaces, natural user interfaces, and the like. For example, a graphical user interface can accept input from a user using an input device, such as a keyboard, a mouse, a remote controller, etc., and provide output on an output device, such as a display. In addition, a natural language interface may enable the user to interact with the data analysis device 100 in a manner without being constrained by the input devices, such as a keyboard, a mouse, a remote controller, and the like. On the contrary, the natural user interface can rely on speech recognition, touch and stylus recognition, gesture recognition on and near the screen, aerial gesture, head and eye tracking, voice and speech, vision, touch, gesture, machine intelligence, and the like.

In addition, although the data analysis device 100 is shown as a single system in the figure, it can be understood that the data analysis device 100 can also be a distributed system and can also be arranged as a cloud facility (including a public cloud or a private cloud). Therefore, for example, several devices can communicate through a network connection and can jointly perform tasks described as being performed by the data analysis device 100.

It should be noted that the detailed description of the process of performing data analysis by the data analysis device 100 can refer to the relevant description in the embodiment of the data analysis method, and the repetition is not repeated here.

Some embodiment of the present disclosure also provide a non-transitory computer-readable storage medium.

For example, in some embodiments, one or more first computer-readable instructions may be stored on a non-transitory computer-readable storage medium. For example, when the first computer-readable instructions are executed by a computer, one or more steps in the processing method of the neural network according to the above description may be performed.

For example, in other embodiments, one or more second computer-readable instructions may also be stored on the non-transitory computer-readable storage medium. In the case where the second computer-readable instructions are executed by a computer, one or more steps in the data analysis method according to the above description may be performed.

For example, in still other embodiments, one or more third computer-readable instructions may also be stored on the non-transitory computer-readable storage medium. In the case where the third computer-readable instructions are executed by a computer, one or more steps in the evaluation method of the neural network according to the above description may be performed.

For the present disclosure, the following statements should be noted:

(1) The accompanying drawings involve only the structure(s) in connection with the embodiment(s) of the present disclosure, and other structure(s) can refer to common design(s).

(2) In case of no conflict, the embodiments of the present disclosure and the features in the embodiment(s) can be combined with each other to obtain new embodiment(s).

What have been described above are only specific implementations of the present disclosure, the protection scope of the present disclosure is not limited thereto, and the protection scope of the present disclosure should be based on the protection scope of the claims.

1. A processing method of a neural network, wherein the neural network comprises at least one nonlinear layer,
the processing method comprises:
processing an input matrix input to an N-th nonlinear layer in the at least one nonlinear layer by using the N-th nonlinear layer to obtain an output matrix output by the N-th nonlinear layer; and
according to the input matrix and the output matrix, performing linearization processing on the N-th nonlinear layer to determine an expression of linear function corresponding to the N-th nonlinear layer,
wherein the expression of the linear function corresponding to the N-th nonlinear layer is expressed as:
f_{LN}=A_{N}*x+B_{N},
where f_{LN} represents the linear function corresponding to the N-th nonlinear layer, A_{N} represents a first parameter of the linear function corresponding to the N-th nonlinear layer, B_{N} represents a second parameter of the linear function corresponding to the N-th nonlinear layer, x represents an input of the N-th nonlinear layer, A_{N} and B_{N} are determined according to the input matrix and the output matrix, N is a positive integer.

2. The processing method according to claim 1, wherein an expression of the first parameter of the linear function corresponding to the N-th nonlinear layer is:
A_{N}=(Df_{NN}) (x1),
where Df_{NN} represents a first derivative of a nonlinear function corresponding to the N-th nonlinear layer, and x1 represents the input matrix; and
an expression of the second parameter of the linear function corresponding to the N-th nonlinear layer is:
B_{N}=f_{NN}(x1)−A*(x1),
where f_{NN} represents the nonlinear function corresponding to the N-th nonlinear layer, and f_{NN} (x1) represents the output matrix.

3. The processing method according to claim 1, further comprising:
performing the linearization processing on all nonlinear layers in the neural network to determine expressions of linear functions respectively corresponding to the all nonlinear layers.

4. The processing method according to claim 1, wherein the at least one nonlinear layer comprises an activation layer, an instance normalization layer, a maximum pooling layer, or a softmax layer, and
an activation function of the activation layer is a ReLU function, a tanh function, or a sigmod function.

5. A data analysis method based on a neural network, comprising:
acquiring input data;
processing the input data by using the neural network to obtain first output data;
according to the input data and the first output data, executing the processing method according to claim 1 to perform the linearization processing on all nonlinear layers in the neural network to determine a linearized neural network corresponding to the neural network; and
analyzing a corresponding relationship between the input data and the first output data based on the linearized neural network.

6. The data analysis method according to claim 5, wherein analyzing the corresponding relationship between the input data and the output data based on the linearized neural network comprises:
determining a detection data group according to the input data, wherein the detection data group is a binary matrix group;
processing the detection data group by using the linearized neural network to obtain a second output data group; and
analyzing a positive influence or a negative influence between the input data and the first output data based on the detection data group and the second output data group.

7. The data analysis method according to claim 6, wherein the detection data group comprises at least one detection data, and the second output data group comprises at least one second output data, the at least one detection data is in one-to-one correspondence to the at least one second output data,
analyzing the positive influence between the input data and the first output data based on the detection data group and the second output data group, comprises:
processing the at least one detection data by using the linearized neural network, respectively, to obtain the at least one second output data; and
determining the positive influence of respective input elements of the input data on respective output elements of the first output data by analyzing a corresponding relationship between the at least one detection data and the at least one second output data at an element level,
wherein each detection data in the detection data group comprises a target detection element, a value of the target detection element is one, and values of other detection elements in each detection data except the target detection element are all zero.

8. The data analysis method according to claim 7, wherein in a case where the detection data group comprises a plurality of detection data, positions of target detection elements in at least part of the plurality of detection data are different.

9. The data analysis method according to claim 8, wherein sizes of the plurality of detection data are identical, and the sizes of the plurality of detection data and a size of the input data are also identical.

10. The data analysis method according to claim 6, wherein the detection data group comprises a plurality of detection data, and the second output data group comprises a plurality of second output data, the plurality of detection data are in one-to-one correspondence to the plurality of second output data,
analyzing the negative influence between the input data and the first output data based on the detection data group and the second output data group, comprises:
processing the plurality of detection data by using the linearized neural network, respectively, to obtain the plurality of second output data; and
determining the negative influence of respective output elements of the output data on respective input elements of the input data by analyzing a corresponding relationship between the plurality of detection data and the plurality of second output data at an element level,
wherein each detection data in the detection data group comprises a target detection element, a value of the target detection element is one, values of other detection elements in each detection data except the target detection element are all zero, an amount of the plurality of detection data is identical to an amount of all detection elements in each detection data, and positions of target detection elements of any two detection data in the plurality of detection data are different.

11. An evaluation method of a neural network, wherein the neural network comprises at least one nonlinear layer, and the evaluation method comprises:
executing a processing method of the neural network to determine at least one linear interpretation unit corresponding to the at least one nonlinear layer; and
evaluating the neural network based on the at least one linear interpretation unit,
wherein the processing method comprises:
processing an input matrix input to an N-th nonlinear layer in the at least one nonlinear layer by using the N-th nonlinear layer to obtain an output matrix output by the N-th nonlinear layer; and
according to the input matrix and the output matrix, performing linearization processing on the N-th nonlinear layer to determine an expression of a linear function corresponding to the N-th nonlinear layer,
wherein the expression of the linear function corresponding to the N-th nonlinear layer is expressed as:
f_{LN}=A_{N}*x+B_{N,}
where f_{LN} represents the linear function corresponding to the N-th nonlinear layer, A_{N} represents a first parameter of the linear function corresponding to the N-th nonlinear layer, B_{N} represents a second parameter of the linear function corresponding to the N-th nonlinear layer, x represents an input of the N-th nonlinear layer, A_{N} and B_{N} are determined according to the input matrix and the output matrix, N is a positive integer.

12. The evaluation method according to claim 11, wherein evaluating the neural network based on the at least one linear interpretation unit, comprises:
evaluating the at least one linear interpretation unit to determine an evaluation result of the at least one nonlinear layer; and
training the neural network based on the evaluation result.

13. The evaluation method according to claim 12, wherein training the neural network based on the evaluation result, comprises:
determining a training weight of the at least one nonlinear layer based on the evaluation result;
acquiring training input data and training target data;
processing the training input data by using the neural network to obtain training output data;
calculating a loss value of a loss function of the neural network according to the training output data and the training target data; and
modifying parameters of the neural network based on the training weight of the at least one nonlinear layer and the loss value, obtaining a trained neural network in a case where the loss function of the neural network satisfies a predetermined condition, and continuously inputting the training input data and the training target data to repeatedly execute the above training process in a case where the loss function of the neural network does not satisfy the predetermined condition.

14. A processing device of a neural network, comprising:
a memory, configured to store computer-readable instructions; and
a processor, configured to execute the computer-readable instructions, wherein a processing method of a neural network is executed in a case where the computer-readable instructions are executed by the processor,
wherein the neural network comprises at least one nonlinear layer,
the processing method of the neutral network comprises:
processing an input matrix input to an N-th nonlinear layer in the at least one nonlinear layer by using the N-th nonlinear layer to obtain an output matrix output by the N-th nonlinear layer; and
according to the input matrix and the output matrix, performing linearization processing on the N-th nonlinear layer to determine an expression of a linear function corresponding to the N-th nonlinear layer,
wherein the expression of the linear function corresponding to the N-th nonlinear layer is expressed as:
f_{LN}=A_{N}*x+B_{N},
wherein f_{LN} represents the linear function corresponding to the N-th nonlinear layer, A_{N} represents a first parameter of the linear function corresponding to the N-th nonlinear layer, B_{N} represents a second parameter of the linear function corresponding to the N-th nonlinear layer, x represents an input of the N-th nonlinear layer, A_{N} and B_{N} are determined according to the input matrix and the output matrix, N is a positive integer.

15. A computer-readable storage medium, for storing computer-readable instructions, wherein the processing method according to claim 1 is executed in a case where the computer-readable instructions are executed by a computer.

16. The processing method according to claim 2, further comprising:
performing the linearization processing on all nonlinear layers in the neural network to determine expressions of linear functions respectively corresponding to the all nonlinear layers.

17. The processing method according to claim 16, wherein the at least one nonlinear layer comprises an activation layer, an instance normalization layer, a maximum pooling layer, or a softmax layer, and
an activation function of the activation layer is a ReLU function, a tanh function, or a sigmod function.

18. The processing method according to claim 2, wherein the at least one nonlinear layer comprises an activation layer, an instance normalization layer, a maximum pooling layer, or a softmax layer, and
an activation function of the activation layer is a ReLU function, a tanh function, or a sigmod function.

19. The processing method according to claim 3, wherein the at least one nonlinear layer comprises an activation layer, an instance normalization layer, a maximum pooling layer, or a softmax layer, and
an activation function of the activation layer is a ReLU function, a tanh function, or a sigmod function.
